(19) United States
(12) Patent Application Publication
(10) Pub. No.: US 2025/0207272 A1
(43) Pub. Date: Jun. 26, 2025

(54) TUBULAR HEATER WITH ALUMINA-FORMING OUTER SURFACE FOR ELECTROCHEMICAL SYSTEMS AND METHODS THEREOF

(71) Applicant: BLOOM ENERGY CORPORATION, San Jose, CA (US)

(72) Inventor: Adil ASHARY, San Jose, CA (US)

(21) Appl. No.: 18/988,199

(22) Filed: Dec. 19, 2024

Related U.S. Application Data
(60) Provisional application No. 63/612,872, filed on Dec. 20, 2023.

(51) Int. Cl. C25B 9/67; C25B 1/042; C25B 9/77; H05B 3/28

(52) U.S. Cl. CPC C25B 9/67; C25B 1/042; C25B 9/77; H05B 3/28

(57) ABSTRACT

Heaters for electrochemical systems, such as electrolyzer cell systems, include an outer sheath having an alumina-forming outer surface to promote the formation of an alumina scale in a high-temperature oxidating environment.

### RELATED APPLICATION

This application claims the benefit of priority of U.S. Provisional Application No. 63/612,872, filed on Dec. 20, 2023, the entire contents of which are incorporated by reference herein for all purposes.

### FIELD

The present invention is directed in general to heaters for electrochemical systems, such as electrolyzer cell systems, and specifically to tubular heaters having an alumina-forming outer surface.

### BACKGROUND

In a solid oxide electrolyzer cell (SOEC), a cathode electrode is separated from an anode electrode by a solid oxide electrolyte. When a SOEC is used to produce hydrogen through electrolysis, a positive potential is applied to the air side of the SOEC and oxygen ions are transported from the fuel (e.g., steam) side to the air side. Throughout this specification, the SOEC anode will be referred to as the air electrode, and the SOEC cathode will be referred to as the fuel electrode. During SOEC operation, water (e.g., steam) in the fuel stream is reduced (H₂O+2e⁻→O²⁻+H₂) to form H₂ gas and O²⁻ ions, the O²⁻ ions are transported through the solid electrolyte, and then oxidized (e.g., by an air inlet stream) on the air side (O²⁻ to O₂) to produce molecular oxygen (e.g., oxygen enriched air).

### SUMMARY

According to various embodiments, a heater for an electrochemical system includes a pair of terminals, and a main body having a heater core including a heating element electrically coupled between the pair of terminals, and an outer sheath surrounding the heater core, where an outer surface of the main body includes at least 2 wt % aluminum.

Further embodiments include the heater incorporated into a hotbox of an electrolyzer cell system including columns of electrolyzer cells disposed in the hotbox.

According to various embodiments, a method of operating an electrolyzer cell system comprising columns of electrolyzer cells and a heater comprising an alumina-forming outer surface disposed within a hotbox is provided. The method comprises providing air and steam to the columns; heating the columns using the heater; electrolyzing the steam in the heated columns to generate hydrogen and oxygen; providing a hydrogen containing product to a hydrogen processor and an oxygen enriched air exhaust stream from the heated columns; and exposing the heater to at least one of the air or the oxygen enriched air exhaust stream to form an oxide scale comprising alumina over an outer surface of the heater.

According to various embodiments, a method of fabricating a heater includes coating an outer sheath of the heater with an aluminide slurry, and performing a heat treatment on the outer sheath coated with the aluminide slurry to form an aluminum-rich coating over the outer sheath of the heater.

### FIGURES

FIG. 1A is a perspective view of a solid oxide electrolyzer cell (SOEC) stack.

FIG. 1B is a side cross-sectional view of a portion of the stack of FIG. 1A.

FIG. 2 is a schematic view of an electrolyzer cell system, according to various embodiments of the present disclosure.

FIG. 3A is a cross-sectional view showing air flow in a hotbox of the electrolyzer cell system of FIG. 2, according to various embodiments of the present disclosure.

FIG. 3B is a cross-sectional view showing steam and hydrogen flow in the hotbox of the electrolyzer cell system of FIG. 2, according to various embodiments of the present disclosure.

FIG. 3C is a top view showing heat transfer in the hotbox of FIG. 2, according to various embodiments of the present disclosure.

FIG. 3D is a perspective view of a distribution hub of FIGS. 3A and 3B, according to various embodiments of the present disclosure.

FIG. 3E is a cross-sectional view of a hotbox, according to an alternative embodiment of the present disclosure.

FIG. 3F is a cross-sectional perspective view of a central column and a support base of the hotbox of FIG. 3E, according to various embodiments of the present disclosure.

FIG. 4A is a cross-sectional view of a central column and support base, according to various embodiments of the present disclosure.

FIG. 4B shows an enlarged portion of FIG. 4A.

FIG. 4C is a perspective view showing the support base and base pan of FIG. 4A.

FIG. 5A is a plan view showing the bottom of the support base of FIG. 4A.

FIG. 5B shows the support base of FIG. 5A with a busbar assembly cover plate removed.

FIG. 5C is a cross-sectional view of the busbar assembly taken along line L1 of FIG. 5A.

FIG. 6A is a perspective view of a heater for an electrochemical system according to various embodiments of the present disclosure.

FIG. 6B is a side elevation view of the heater of FIG. 6A.

FIG. 6C is a bottom view of the heater of FIG. 6A.

FIG. 6D is a cross-sectional view of a portion of the heater of FIG. 6A.

FIG. 7 is a cross-section view of a portion of the main body of a tubular heater illustrating the formation of an oxide scale over the outer surface of the outer sheath of the heater according to various embodiments of the present disclosure.

FIG. 8A is a cross-section view of a portion of a main body of a heater according to an alternative embodiment of the present disclosure.

FIG. 8B is a cross-section view of the portion of the main body of the heater of FIG. 8A illustrating the formation of an oxide scale over the outer surface of an outer coating of the heater according to the alternative embodiment of the present disclosure.

### DETAILED DESCRIPTION

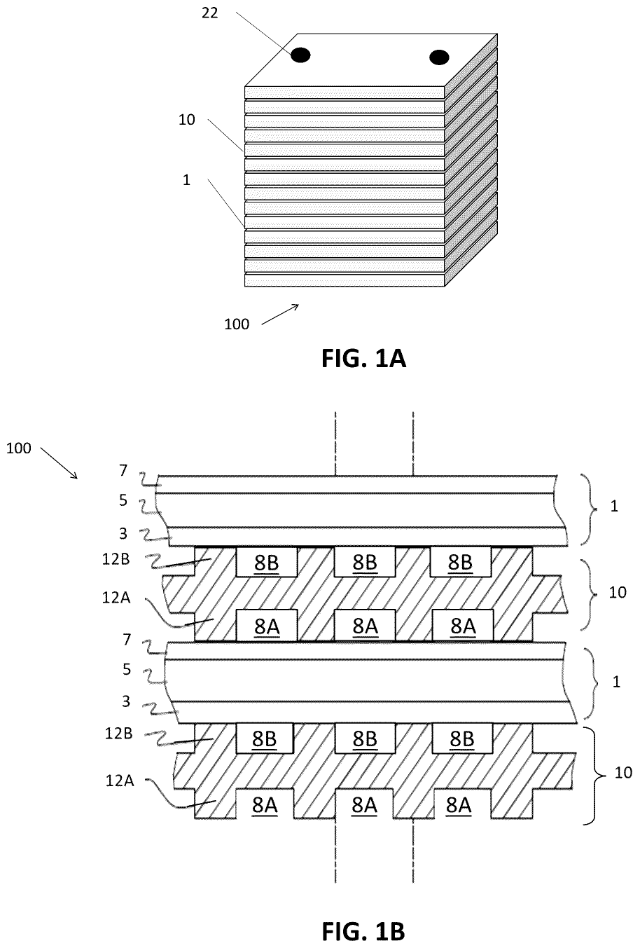

FIG. 1A is a perspective view of an electrolyzer cell stack 100, such as a solid oxide electrolyzer cell (SOEC) stack, and FIG. 1B is a side cross-sectional view of a portion of the stack 100 of FIG. 1A. Referring to FIGS. 1A and 1B, the stack 100 includes multiple electrolyzer cells (e.g., SOECs) 1 that are separated by interconnects 10, which may also be referred to as gas flow separator plates or bipolar plates. Each electrolyzer cell 1 includes an air electrode 3, an electrolyte 5, such as a solid oxide electrolyte for a SOEC, and a fuel electrode 7. The stack 100 also includes internal fuel riser channels 22.

Each interconnect 10 electrically connects adjacent electrolyzer cells 1 in the stack 100. In particular, an interconnect 10 may electrically connect the fuel electrode 7 of one electrolyzer cell 1 to the air electrode 3 of an adjacent electrolyzer cell 1. FIG. 1B shows that the lower electrolyzer cell 1 is located between two interconnects 10.

Various materials may be used for the air electrode 3, electrolyte 5, and fuel electrode 7. For example, the air electrode 3 may comprise an electrically conductive material, such as an electrically conductive perovskite material, such as lanthanum strontium manganite (LSM). Other conductive perovskites, such as LSCo, etc., or metals, such as Pt, may also be used. The electrolyte 5 may comprise a stabilized zirconia, such as scandia stabilized zirconia (SSZ) or yttria stabilized zirconia (YSZ), yttria-ceria-stabilized zirconia (YCSZ), ytterbia-ceria-scandia-stabilized zirconia (YbCSSZ), or blends thereof. In YbCSSZ, scandia may be present in an amount equal to 9 to 11 mol %, such as 10 mol %, ceria may present in amount greater than 0 and equal to or less than 3 mol %, for example 0.5 mol % to 2.5 mol %, such as 1 mol %, and ytterbia may be present in an amount greater than 0 and equal to or less than 2.5 mol %, for example 0.5 mol % to 2 mol %, such as 1 mol %, as disclosed in U.S. Pat. No. 8,580,456, which is incorporated herein by reference. Alternatively, the electrolyte 5 may comprise another ionically conductive material, such as a doped ceria. The fuel electrode 7 may comprise a cermet comprising a nickel containing phase and a ceramic phase. The nickel containing phase may consist entirely of nickel in a reduced state. The ceramic phase may comprise a stabilized zirconia, such as yttria and/or scandia stabilized zirconia and/or a doped ceria, such as gadolinia, yttria and/or samaria doped ceria. The electrodes and the electrolyte may each comprise one or more sublayers of one or more of the above described materials.

Each interconnect 10 includes fuel ribs 12A that at least partially define fuel channels 8A, and air ribs 12B that at least partially define air channels 8B. The interconnect 10 may operate as a gas-fuel separator that separates a fuel, such as steam, flowing to the fuel electrode 7 of one electrolyzer cell 1 in the stack 100 from oxidant, such as air, flowing to the air electrode 3 of an adjacent electrolyzer cell 1 in the stack 100. At either end of the stack 100, there may be an air end plate or fuel end plate (not shown) for providing air or fuel, respectively, to the end electrode. Alternatively, the air end plate or fuel end plate may comprise the same interconnect structure used throughout the stack.

Each interconnect 10 may be made of or may contain electrically conductive material, such as a metal alloy (e.g., chromium-iron alloy) which has a similar coefficient of thermal expansion to that of the solid oxide electrolyte in the cells (e.g., a difference of 0-10%). For example, the interconnects 10 may comprise a metal (e.g., a chromium-iron alloy, such as 4-6 weight percent iron, optionally 1 or less weight percent yttrium and balance chromium alloy). Alternatively, any other suitable conductive interconnect material, such as stainless steel (e.g., ferritic stainless steel, SS446, SS430, etc.) or iron-chromium alloy (e.g., Crofer™ 22 APU alloy which contains 20 to 24 wt. % Cr, less than 1 wt. % Mn, Ti and La, and balance Fe, or ZMG™ 232L alloy which contains 21 to 23 wt. % Cr, 1 wt. % Mn and less than 1 wt. % Si, C, Ni, Al, Zr and La, and balance Fe) may be used.

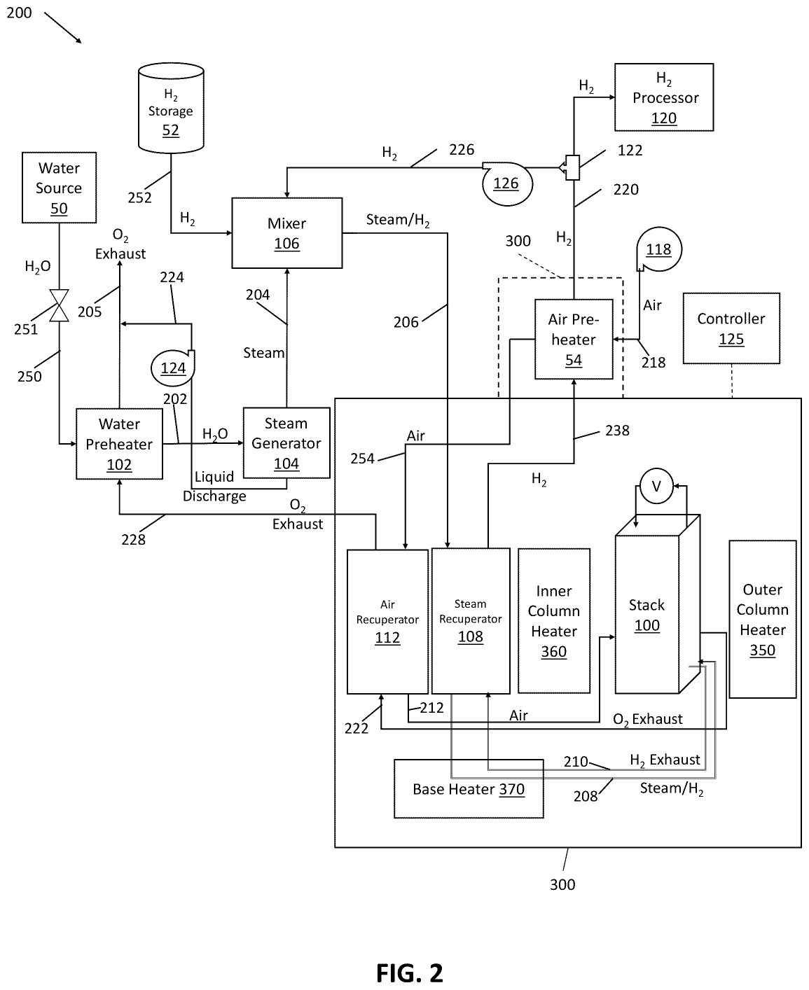

FIG. 2 is schematic view of an electrolyzer cell system 200, according to various embodiments of the present disclosure. Referring to FIGS. 1A, 1B, and 2, the system 200 may include one or more electrolyzer cell stacks 100 or columns, such as SOEC stacks or columns. Each column may include one or more electrolyzer cell stacks 100. The electrolyzer cell stack 100 includes multiple electrolyzer cells, such as SOECs, as described with respect to FIGS. 1A and 1B. The system 200 may also include a steam generator 104, a steam recuperator heat exchanger 108, an air recuperator heat exchanger 112, an air blower 118, a recycle blower 126, an outer column heater 350, an inner column heater 360, and a base heater 370. The system 200 may also optionally include at least one of an air pre-heater heat exchanger 54, a water preheater heat exchanger 102, a mixer 106, a hydrogen processor 120 and/or a hydrogen separator (e.g., splitter or valve) 122.

The system 200 may include a hotbox 300 that houses various components, such as the stack 100, the steam recuperator 108, the air recuperator 112, the outer column heater 350, the inner column heater 360 and/or the base heater 370. In some embodiments, the hotbox 300 may include multiple stacks 100 or multiple columns of stacks 100. The water preheater 102 and the steam generator 104 may be located external to the hotbox 300, as shown in FIG. 2. Alternatively, the water preheater 102 and/or the steam generator 104 may be located inside the hotbox 300. In another alternative embodiment, the SOEC system may have an external steam source, in which case the water preheater 102 and/or the steam generator 104 may be omitted.

During operation, the stack 100 may be provided with steam (e.g., steam inlet stream) and electric power (e.g., current or voltage) from an external power source. In particular, the steam may be provided to the fuel electrodes 7 of the electrolyzer cells 1 of the stack 100, and the power source may apply a voltage between the fuel electrodes 7 and the air electrodes 3, in order to electrochemically split water (e.g., steam) molecules and generate hydrogen and oxygen. Air may also be provided to the air electrodes 3, in order to sweep the oxygen from the air electrodes 3. As such, the stack 100 may output a hydrogen stream and an oxygen-rich exhaust stream, such as an oxygen-rich air stream (“oxygen exhaust stream”).

In order to generate the steam, water may be provided to the system 200 from a water source 50. The water source 50 may include a municipal water supply (e.g., water pipe) and/or a water storage tank. The water may be deionized (DI) water that is deionized as much as is practical (e.g., <0.1 μS/cm), in order to prevent and/or minimize scaling during vaporization. In some embodiments, the water source 50 may include one or more deionization beds (e.g., downstream of the water pipe or tank). The water source 50 may provide the water to the system 200 via a water inlet conduit 250. In various embodiments, the water inlet conduit 250 may include a water flow control device 251 such as a valve, a mass flow controller, a positive displacement pump, a water flow meter, or the like, in order to provide a desired water flow rate to the system 200.

If the system 200 includes the water preheater 102, the water may be provided from the water source 50 to the water preheater 102 through the water inlet conduit 250. The water preheater 102 may be a heat exchanger configured to heat the water using heat recovered from the oxygen exhaust stream from the stack 100. Preheating the water may reduce the total power consumption of the system 200 per unit of hydrogen generated. In particular, the water preheater 102 may recover heat from the oxygen exhaust stream that may not be recoverable by the air recuperator 112, as discussed below. The water preheater may heat the water to a temperature above 50° C., such as a temperature of about 70° C. to 80° C. The oxygen exhaust stream may be output from the water preheater 102 at a temperature above 80° C., such as above 100° C., such as a temperature of about 120° C. to 140° C.

The water output from the water preheater 102 (or from the water source 50 if the water preheater 102 is omitted) may be provided to the steam generator 104 through a water conduit 202. The steam generator 104 may be configured to heat the water to convert the water into steam. The steam generator 104 may include a heating element to vaporize the water and generate steam. For example, the steam generator 104 may include an AC or DC resistance heating element or an induction heating element. Alternatively, the steam generator 104 may comprise a heat exchanger which is located inside the hotbox 300 and which is heated by one or more hot exhaust streams flowing through the hotbox 300. The steam generator 104 heats the water above 100° C. to generate steam, such as a temperature of about 120° C. to 145° C.

The steam generator 104 may include multiple zones/elements that may or may not be mechanically separate. For example, the steam generator 104 may include a pre-boiler to heat the water up to or near to the boiling point. The steam generator 104 may also include a vaporizer configured to convert the pre-boiled water into steam. The steam generator 104 may also include a deaerator to provide a relatively small purge of steam to remove dissolved air from the water prior to bulk vaporization. The steam generator 104 may also include an optional superheater configured to further increase the temperature of the steam generated in the vaporizer. The steam generator 104 may include a demister pad located downstream of the heating element and/or upstream from the super heater. The demister pad may be configured to minimize entrainment of liquid water in the steam output from the steam generator 104 and/or provided to the superheater.

If the steam product is superheated, it will be less likely to condense downstream from the steam generator 104 due to heat loss. Avoidance of condensation is preferable, as condensed water is more likely to form slugs of water that may cause significant variation of the delivered mass flow rate with respect to time. It may also be beneficial to avoid excess superheating, in order to limit the total power consumption of the system 200. For example, the steam may be superheated by an amount ranging from about 10° C. to about 100° C.

In some embodiments, a small amount of liquid water (e.g., from about 0.5% to about 2% of incoming water) may be periodically or continuously discharged from the steam generator 104 via a liquid discharge conduit 224. In particular, the discharged liquid water may include scale and/or other mineral impurities that may accumulate in the steam generator 104 while vaporizing water to generate steam. Therefore, this discharged liquid water is not desirable for being recycled into the water inlet stream from the water source 50. This liquid discharge may be mixed with the hot oxygen exhaust stream output from the water preheater 102 into an exhaust conduit 205. If the hot oxygen exhaust stream has a temperature above 100° C., such as 120 to 140° C., the liquid water discharge may be evaporated by the hot oxygen exhaust stream, such that no liquid water is required to be discharged from the system 200. The system 200 may optionally include a water pump 124 configured to pump and regulate the liquid water discharge in the liquid discharge conduit 224 output from the steam generator 104 into the exhaust conduit 205 from the water preheater 102. Optionally, a flow regulator, such as proportional solenoid valve, may be added to the liquid discharge conduit 224 in addition to the pump 124 to additionally regulate the flow of the liquid water discharge.

Blowdown from the steam generator 104 may be beneficial for long term operation, as the water will likely contain some amount of mineralization after deionization. Typical liquid blowdown may be on the order of 1%. The blowdown may be continuous, or may be intermittent, e.g., ten times the steady state flow for 6 seconds out of every minute, five times the steady state flow for 1 minute out of every 5 minutes, etc. The need for a water discharge stream can be eliminated by pumping the blowdown into the hot oxygen exhaust. In this case, the pump 124 and liquid discharge conduit 224 may be omitted.

The steam output from the steam generator 104 may be provided to the steam recuperator 108 via a steam conduit 204. However, if the system 200 includes the optional mixer 106, the steam may be provided to the mixer 106 prior to being provided to the steam recuperator 108 via the steam and hydrogen conduit 206. In particular, the steam may include small amounts of dissolved air and/or oxygen. The mixer 106 may be configured to mix the steam with hydrogen gas, in order to maintain a reducing environment in the stack 100, and in particular, at the fuel electrodes 7.

The mixer 106 may be configured to mix the steam with hydrogen received from a hydrogen storage device (e.g., hydrogen storage vessel) 52 and/or with a portion of the hydrogen and steam recycle stream output from the stack 100. The hydrogen addition rate may be set to provide an amount of hydrogen that exceeds an amount of hydrogen needed to react with an amount of oxygen dissolved in the steam. The hydrogen addition rate may either be fixed or set to a constant water to hydrogen ratio. However, if the steam is formed using water that is fully deaerated, the mixer 106 and/or hydrogen addition into the steam may optionally be omitted.

In some embodiments, the hydrogen may be provided to the mixer 106 during system startup and shutdown modes, and optionally during steady-state operation modes. For example, during the startup and shutdown modes (or other modes where the system 200 is not generating hydrogen, such as a fault mode), the hydrogen may be provided to the mixer 106 from the hydrogen storage device 52 via a stored hydrogen conduit 252. A valve (not shown) may be utilized on stored hydrogen conduit 252 to regulate the flow of hydrogen from the hydrogen storage device 52 to mixer 106. The operating state of the valve may be controlled by controller 125.

During the steady-state operating mode, the hydrogen flow from the hydrogen storage device 52 may be stopped (e.g., by shutting off the outlet valve from the hydrogen storage device). A first portion of a hydrogen exhaust stream (e.g., the hydrogen and steam product steam) generated by the stack 100 is diverted to the mixer 106 through the hydrogen recycle conduit 226 by the recycle blower 126. In particular, the system 200 may include a hydrogen separator 122, such as a splitter and/or valve, configured to selectively divert a portion of the hydrogen exhaust stream flowing through the hydrogen product conduit 220 to the mixer 106 during the steady-state mode operation.

The mixed steam and hydrogen inlet stream is provided from the mixer 106 into a steam recuperator heat exchanger 108 via a steam and hydrogen conduit 206. The mixed steam and hydrogen inlet stream in conduit 206 may have a temperature above 100° C., such as 120° C. to 140° C. The mixed steam and hydrogen inlet stream is heated in the steam recuperator 108 by the hydrogen exhaust (i.e., the hydrogen and steam product stream) provided from the stack 100. The hydrogen exhaust may be provided from the stack 100 to the steam recuperator 108 via a hydrogen outlet conduit 210. The heated mixed steam and hydrogen inlet stream is provided from the steam recuperator heat exchanger 108 into the fuel side inlet of the stack 100 via the fuel inlet conduit 208. The mixed steam and hydrogen inlet stream in the fuel inlet conduit 208 may have a temperature above 500° C., such as 550° C. to 600° C.

The hydrogen exhaust is output from the hotbox 300 (e.g., from the steam recuperator 108 and/or the optional air preheater 54) into the hydrogen product conduit 220 at a temperature of 150° C. to 250° C. A second portion of the hydrogen exhaust that is not diverted by the hydrogen separator 122 into the mixer 106 continues through the hydrogen product conduit 220 into the hydrogen processor 120. The hydrogen exhaust may be compressed and/or purified in the hydrogen processor 120. The hydrogen processor 120 may include a high temperature hydrogen pump that operates at a temperature of from about 120° C. to about 200° C., in order to remove from about 70% to about 90% of the hydrogen from the hydrogen exhaust. The removed hydrogen is stored and/or provided for one or more end uses. In one embodiment, the hydrogen processor 120 includes an electrochemical hydrogen pump, a liquid ring compressor, a diaphragm compressor or combination thereof. For example, the hydrogen processor may include a series of electrochemical hydrogen pumps, which may be disposed in series and/or in parallel with respect to a flow direction of the hydrogen exhaust, in order to compress the hydrogen exhaust. The final product from compression may still contain traces of water. As such, the hydrogen processor 120 may optionally include a dewatering device, such as a condenser, a temperature swing adsorption reactor, or a pressure swing adsorption reactor, to remove this residual water, if necessary.

The air recuperator heat exchanger 112 may be provided with ambient air by an air blower 118 via an air inlet conduit 218 and an optional preheated air conduit 254. The oxygen exhaust output from the stack 100 may be provided to the air recuperator 112 via an oxygen outlet conduit 222. The air recuperator 112 may be configured to heat the air using heat extracted from the stack oxygen exhaust (i.e., the oxygen enriched air). The air inlet stream may be heated in the air recuperator 112 to a temperature above 500° C., such as 550° C. to 600° C. The heated air inlet stream is provided from the air recuperator 112 to the air inlet of the stack 100 via the stack air inlet conduit 212.

The oxygen exhaust is output from the air recuperator 112 to the water preheater 102 via the oxygen exhaust conduit 228 at temperature above 200° C., such as 250° C. to 350° C. The oxygen exhaust is output from the water preheater 102 via the exhaust conduit 205 at temperature of at least 80° C., such as 120° C. to 140° C.

According to various embodiments, the system 200 may include an optional air preheater heat exchanger 54 disposed outside or inside of the hotbox 300. In particular, the air preheater 54 may be configured to preheat the air inlet stream provided to the hotbox 300 by the air blower 118 via the air inlet conduit 218 using heat in the hydrogen exhaust (i.e., the hydrogen and steam product stream) from the stack 100. The air may be preheated in the air preheater to a temperature above 100° C., such as 150° C. to 250° C. The hydrogen exhaust may be provided from the steam recuperator 108 to the air preheater 54 via a hydrogen conduit 238.

According to various embodiments, the system 200 may include a controller 125, such as a central processing unit, which is configured to control the operation of the system 200. For example, the controller 125 may be wired or wirelessly connected to various elements of the system 200 to control the same.

According to various embodiments, the SOEC stack 100 may generate hydrogen at an operating temperature ranging from about 700° C. to 900° C., such as from about 725° C. to about 775° C., or about 750° C. In order to maintain the stack operating temperature, fluids provided to the stack 100 may be heated by various components prior to being provided to the stack 100.

Size constraints within the hotbox 300 may limit the maximum size of the steam recuperator 108 and the air recuperator 112. As such, it may be difficult to achieve desired steam and air output temperatures, while at the same time providing a high flow rate and a low pressure drop for efficient system operation. For example, for a small sized recuperator to have a high output temperature, the recuperator may have a high pressure drop and/or a low flow rate. As such, hotbox size limitations may make it difficult for recuperators to output steam and air at stack operating temperatures and at desired flow rates, without having an undesirably high pressure drop. In some embodiments, one or more thermal control components, such as heaters 350, 360, 370 and air recuperator 112 may be located in the hotbox 300, such as radially inwards from the stacks 100. The thermal control components may help to improve the temperature control of the system.

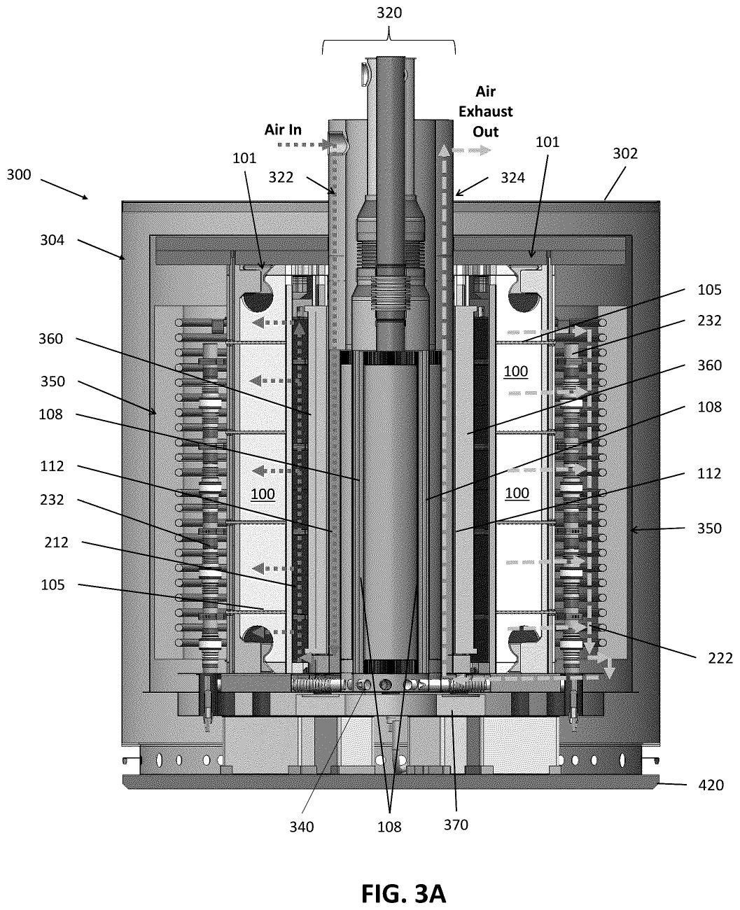

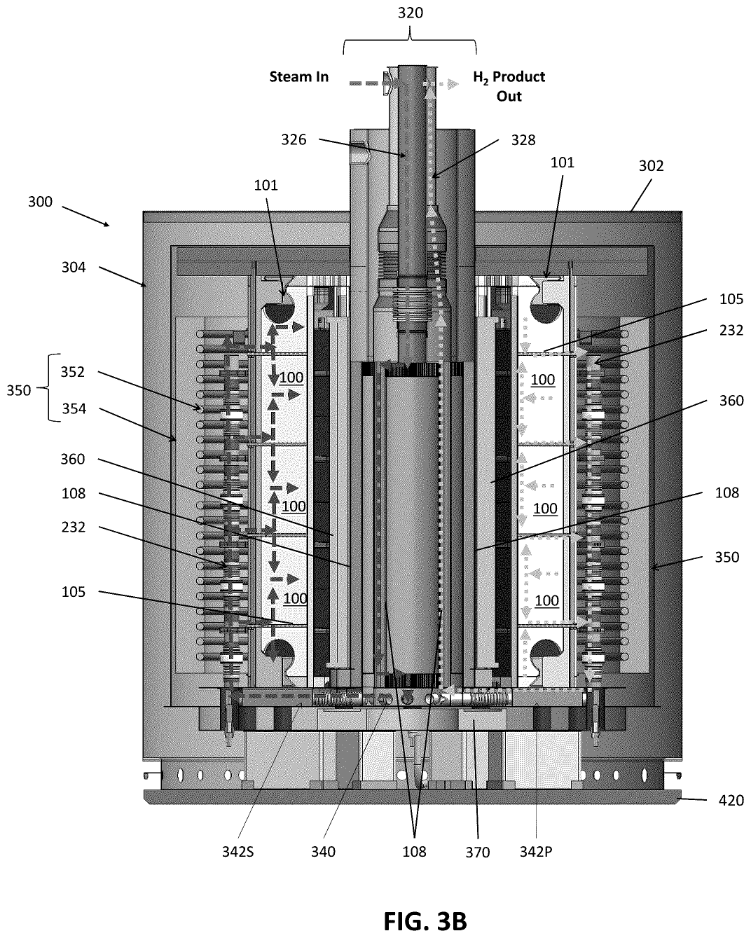

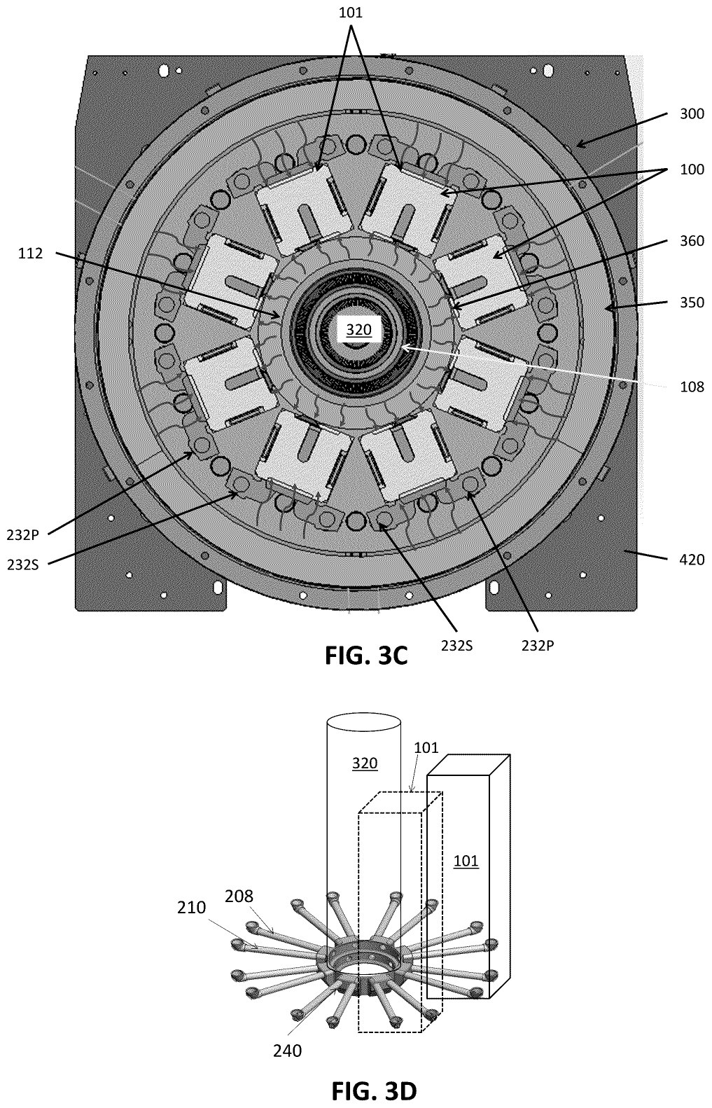

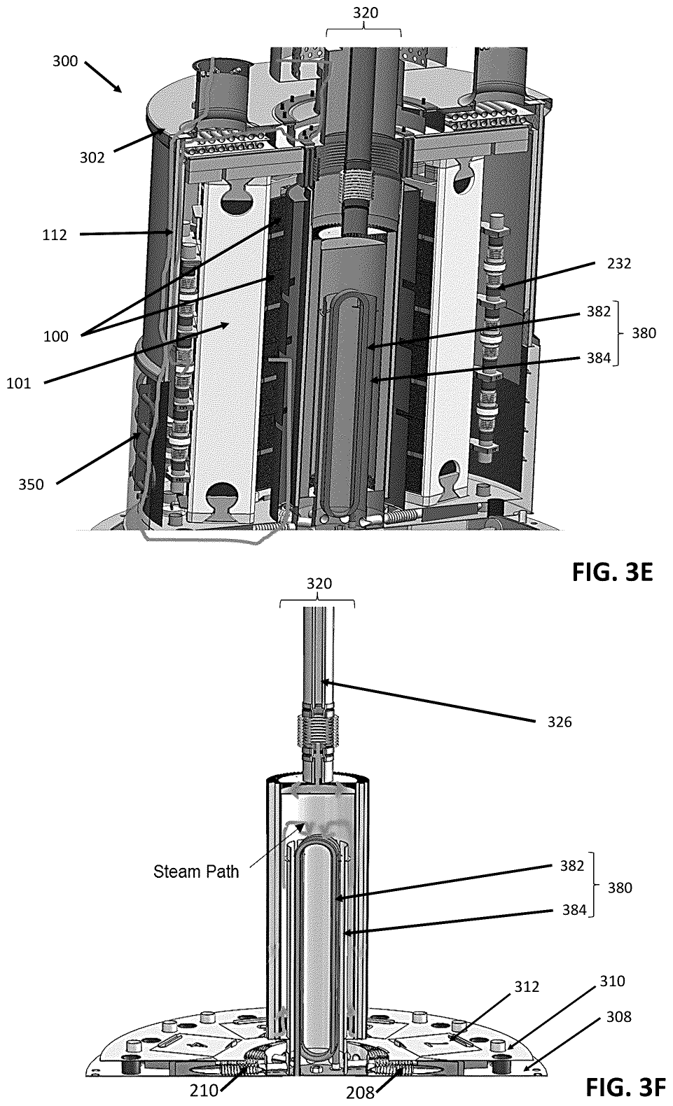

FIGS. 3A and 3B are cross-sectional views showing air flow and steam and hydrogen flow in the hotbox 300 of the electrolyzer cell system 200 of FIG. 2, according to various embodiments of the present disclosure. FIG. 3C is a top view showing aspects of heat transfer in the hotbox 300 of FIG. 2, according to various embodiments of the present disclosure.

Referring to FIGS. 3A-3C, the hotbox 300 may be disposed on a support base 420 and may include an optional cover plate 302 and one or more sidewall(s) 304 (e.g., a single cylindrical sidewall). The support base 420 may allow a forklift to raise and move the hotbox 300. The hotbox 300 includes a central column 320, an outer column heater 350, an inner column heater 360, and a base heater 370, which may be disposed in the hotbox 300. In particular, the central column 320 may protrude through an opening in the cover plate 302 of the hotbox 300.

The central column 320 may include a steam recuperator 108 and an air recuperator 112. In various embodiments, the air recuperator 112 may be located radially outward from and may concentrically surround the steam recuperator 108. It is believed that this configuration may provide a high heat transfer efficiency. However, in alternative embodiments, the air recuperator 112 may optionally be located radially inward from and may be laterally surrounded by the steam recuperator 108 instead. Thus, both the steam recuperator 108 and the air recuperator 112 may be located radially inward of the stacks 100 or cell columns 101. The central column 320 may also include an air conduit 322, an air exhaust conduit 324, a steam conduit 326 (see FIG. 3B), and a product conduit 328 (see FIG. 3B). The air conduit 322 comprises a combination of the preheated air conduit 254 and the stack air inlet conduit 212. The air exhaust conduit 324 comprises a combination of the oxygen outlet conduit 222 and the oxygen exhaust conduit 228. The steam conduit 326 comprises a combination of the steam and hydrogen conduit 206 and the fuel inlet conduit 208. The product conduit 328 comprises a combination of the hydrogen outlet conduit 210 and the hydrogen conduit 238.

The cell columns 101 may each include one stack 100 or plural stacks 100 stacked over each other. The cell columns 101 surround around the central column 320. The cell columns 101 may optionally include fuel manifolds 105 (e.g., steam splitter plates) disposed between the stacks 100. The manifolds 105 may be configured to provide steam to adjacent stacks 100 in the same column 101 and receive the hydrogen product output from adjacent stacks 100 in the same column 101. The manifolds 105 of each cell column 101 may be fluidly connected to riser conduits 232 configured to provide the steam to and collect the hydrogen exhaust from the cell columns 101. The riser conduits 232 may include steam riser conduits 232S configured to provide the steam inlet stream to the cell columns 101, and product riser conduits 232P configured to collect the hydrogen exhaust stream (i.e., the hydrogen product stream) output from the cell columns 101, as shown in FIG. 3C.

Thus, the cell columns 101 and/or stacks 100 may be internally manifolded for steam/hydrogen and externally manifolded for oxygen/air. As noted above, the steam inlet stream may also include hydrogen, and the hydrogen product may also include unreacted steam. Alternatively, each cell column 101 may include only one stack 100 and the manifolds 105 and riser conduits 232 may be omitted. In another alternative embodiment, the cell columns 101 and/or stacks 100 may be internally manifolded for both steam/hydrogen and oxygen/air using interconnects and stacks such as those disclosed in U.S. Provisional Application No. 63/598,678 (Internally Manifolded Interconnects with Plural Flow Directions and Electrochemical Cell Column Including Same), filed on Nov. 14, 2023, the contents of which are incorporated herein by reference in their entirety.

Referring to FIG. 3D, the central column 320 may be disposed on and fluidly connected to a distribution hub 240. The distribution hub 240 may be configured to fluidly connect the central column 320 to the stacks 100 or columns 101. While only two columns 101 are shown in FIG. 3D, the distribution hub 240 may be fluidly connected to all the stacks 100 or columns 101 included in the hotbox 300. The distribution hub 240 may be fluidly connected to the riser conduits 232 by the reactant inlet conduits (i.e., steam distribution conduits) 208 and hydrogen outlet conduits (i.e., product collection conduits) 210 as shown in FIG. 3B. In particular, the reactant inlet conduits 208 may be fluidly connected to the steam riser conduits 232S, and the hydrogen outlet conduits 210 may be fluidly connected to the product riser conduits 232P.

The fuel inlet conduits 208 may be configured to distribute steam output from the steam and hydrogen conduit 206 and the steam recuperator 108 in the central column 320 through the distribution hub 240 to the riser conduits 232. The hydrogen outlet conduits 210 may be configured to receive the hydrogen exhaust stream generated by the stacks 100 and output through the product riser conduits 232P and the distribution hub 240 to the steam recuperator 108 and the hydrogen conduit 238.

The inner column heater 360 may be disposed between the central column 320 and the cell columns 101 (e.g., one or more stacks 100). In particular, an inner surface of the inner column heater 360 may face the steam recuperator 108 and the air recuperator 112, and an outer surface of the inner column heater 360 may face the stacks 100 or columns 101. The outer column heater 350 may surround the stacks 100 or columns 101. In particular, an inner surface of the outer column heater 350 may face the stacks 100. Thus, the stacks 100 or columns 101 are located radially inward from the outer column heater 350 and radially outward from the inner column heater 360. The steam recuperator 108 and the air recuperator 112 are located radially inward from the inner column heater 360.

As shown in FIG. 3A, in operation, an incoming air inlet stream is provided through the air conduit 322 (e.g., through the preheated air conduit 254) to the top of the air recuperator 112. The air inlet stream may be heated while passing through the air recuperator 112, before exiting the bottom of the air recuperator 112. After exiting the air recuperator 112, the air inlet stream may flow upward through the stack air inlet conduit 212 to the inner facing surfaces of the stacks 100 or columns 101. The inner column heater 360 may heat the air inlet stream in the stack air inlet conduit 212. The air inlet stream may enter the open inner (i.e., radially inward) surfaces of the stacks 100 or columns 101 that face the central column 320. The air inlet stream may flow to the surface of the SOEC air electrodes 3 in the stacks 100 or columns 101 via the air channels 8B in the interconnects 10 (see FIG. 1B). Oxygen ions generated from the steam inlet stream at the fuel electrodes 7 by a voltage applied to the stacks 100 may pass through the SOEC electrolytes 5 and may recombine to form oxygen gas (O₂) at the air electrodes 3. The oxygen gas is swept away by the air inlet stream flowing through the air channels 8B in the stacks 100 or columns 101. The oxygen enriched air (e.g., oxygen/air exhaust) stream then exits outer (i.e., radially outward) surfaces of the stacks 100 or columns 101, flows downward through the oxygen outlet conduit 222 toward the bottom of the hotbox 300, and then flows into the bottom of the air recuperator 112. The outer column heater 350 may heat the oxygen enriched air in the oxygen outlet conduit 222. The air recuperator 112 extracts heat from the oxygen exhaust stream as it flows upward through the air recuperator 112, to heat the incoming air inlet stream.

As shown in FIG. 3B, in operation, steam and/or a steam/hydrogen mixture is provided to the central column 320 and flows downward through the steam conduit 326 (e.g., through the steam and hydrogen conduit 206) to the steam recuperator 108. The steam recuperator 108 may be a heat exchanger configured to recover heat from the hydrogen exhaust stream output from the stacks 100 or columns 101. As such, the steam recuperator 108 may be configured to increase the efficiency of the system 200.

The heated steam inlet stream may exit the bottom of the steam recuperator 108 and enter the distribution hub 240. The steam inlet stream may then flow through the fuel inlet conduits 208 to the corresponding riser conduits 232 (e.g., steam riser conduits 232S), which provide the steam inlet stream to the stacks 100 or columns 101. The steam and/or the steam/hydrogen mixture (i.e., the steam inlet stream) flowing through the fuel inlet conduits 208 is heated by the base heater 370 located adjacent to the distribution hub 240. The steam and/or the steam/hydrogen mixture flows to the SOEC fuel electrodes 7 in the stacks 100 or columns 101 via the fuel channels 8A in the interconnects 10. The SOECs in the stacks 100 or columns 101 may convert at least a portion of the steam into hydrogen to generate a hydrogen exhaust stream (i.e., product stream) that may also comprise unreacted steam. The hydrogen exhaust stream may be output from the stacks 100 or columns 101 to the corresponding riser conduits 232 (e.g., product riser conduits 232P). The hydrogen exhaust stream may be provided from the product riser conduits 232P to the distribution hub 240 by the hydrogen outlet conduits 210, which may provide the hydrogen exhaust stream to the bottom of the steam recuperator 108. The hydrogen exhaust stream flowing through the hydrogen outlet conduits 210 is heated by the base heater 370 located adjacent to the distribution hub 240. The hydrogen exhaust stream may flow up through the steam recuperator 108, which may transfer heat from the hydrogen exhaust stream to the incoming steam inlet stream flowing therethrough in the opposite direction. The hydrogen exhaust stream may exit the top of the steam recuperator 108 and enter the hydrogen conduit 328 and then exit the central column 320.

In various embodiments, in order for the recuperators 108, 112 to provide high steam and air flow rates and a low pressure drop while also fitting within the space available in the hotbox 300, the temperature of the steam inlet stream and/or air inlet stream may be less than a desired operating temperature of the stacks 100 or columns 101. Accordingly, the heaters 350, 360, 370 may be used to supplement the heating provided by the recuperators 108, 112.

For example, the heaters 350, 360, 370 may be configured to heat the air inlet stream, the steam/hydrogen stream (i.e., the steam inlet stream), the hydrogen exhaust stream and/or the oxygen enriched air stream (i.e., oxygen exhaust stream) such that the steam inlet stream and the air inlet stream are provided to the stacks 100 or columns 101 at temperatures as close as possible to the operating temperature of the stack, such as at temperatures ranging from about 700° C. to about 900° C., such as from about 725° C. to about 850° C., or about 750° C. However, higher temperatures may also be used.

In various embodiments, the heaters 350, 360, 370 may include electric heating elements, such as resistive or inductive heating elements which may be embedded in thermal insulation layers. In some embodiments, the heaters 350, 360, 370 may preferably comprise heating elements disposed in a ceramic fiber insulation material, in order to provide longer heater life. For example, as shown in FIG. 3B, the outer column heater 350 may include one or more heating elements 352 embedded in a tubular insulation layer 354, which may be formed of ceramic fibers.

In some embodiments, the heaters 350, 360, 370 may include different heating zones in order to provide improved temperature control. For example, the column heaters 350, 360 may have upper, middle, and lower zones, including independently controllable heating elements, in order to heat upper, middle, and lower portions of the stacks 100 or columns 101 at different temperatures, depending on the temperature requirements of different portions of the stacks 100 or columns 101. In such embodiments, system 200 controller 125 is configured to independently control the upper, middle, and lower heating zone temperatures for each column heater 350, 360.

In various embodiments, the outer column heater 350 may be disposed along the perimeter of the hotbox 300 and may be configured to radiate heat inward toward the central column 320 and the cell columns 101. For example, the outer column heater 350 may be configured to radiate heat toward the outer (i.e., radially outward) surfaces of the stacks 100, columns 101 and/or the riser conduits 232. Accordingly, the outer column heater 350 may be configured to heat the stacks 100 or columns 101 and fluids flowing through the riser conduits 232. The base heater 370 may be configured to heat fluids flowing through the distribution hub 240. For example, the base heater 370 may directly or indirectly heat the conduits 208 and 210 to heat the fluids flowing therethrough. For example, the base heater 370 may be configured to heat a steam/hydrogen mixture (i.e., the steam inlet stream) flowing through the fuel inlet conduits 208 up to the stack operating temperature. In some embodiments, the base heater 370 may also heat the hydrogen exhaust stream flowing through the hydrogen outlet conduits 210, in order to increase the amount of heat transferred to the steam inlet stream in the steam recuperator 108.

Depending on the health of the stacks 100, the water utilization rate of the stacks 100, and the air flow rate to the stacks 100, the outer column heater 350 and/or base heater 370 may heat steam or steam/hydrogen mixture provided to the stacks 100 to a temperature ranging from about 700° C. to about 900° C., such as 725° C. to 800° C., or about 750° C. In some embodiments, the outer column heater 350 and/or base heater 370 may increase the temperature of the steam output from the steam recuperator 108 by an amount ranging from about 50° C. to about 300° C., such as from about 75° C. to about 200° C., or from about 100° C. to about 150° C. Accordingly, the stacks 100 may be provided with steam or a steam-hydrogen mixture having a temperature that allows for efficient hydrogen generation.

The inner column heater 360 may surround the central column 320, such that an outer surface of inner column heater 360 faces inner (i.e., radially inward) surfaces of the stacks 100 or columns 101 and an inner surface of the inner column heater 360 faces the central column 320 and/or the air recuperator 112. The inner column heater 360 may be configured to heat the stacks 100 or columns 101, for example, by radiating heat outward toward the inner surfaces of the stacks 100 or columns 101. The inner column heater 360 may also heat the air recuperator 112, in order to increase the temperature of the air inlet stream flowing along the outer surface of the air recuperator 112.

In some embodiments, the inner column heater 360 may be configured to heat the air inlet stream provided to the stacks 100 or columns 101, including air in the air recuperator 112 and/or the air inlet stream flowing through the hotbox 300, to a temperature ranging from about 700° C. to about 900° C., such as 725° C. to 800° C., or about 750° C. For example, the inner column heater 360 may be configured to increase the temperature of the air inlet stream output from the air recuperator 112 by an amount ranging from about 100° C. to about 400° C., such as from about 150° C. to about 350° C., or from about 250° C. to about 275° C.

Accordingly, the heaters 350, 360, 370 may be configured to heat the stacks 100 or columns 101, and/or steam inlet stream and air inlet stream provided to the stacks 100 or columns 101, to maintain a desired stack operating temperature and hydrogen production efficiency, without increasing a footprint and/or volume of the hotbox 300. Accordingly, the heaters 350, 360, 370 may beneficially allow for the use of relatively small recuperators 108, 112, while maintaining overall system space and hydrogen production efficiency.

In an alternative embodiment shown in FIGS. 3E and 3F, the air recuperator 112 may be located radially outside of the cell columns 101, and an additional steam heater 380 may be located in the central column 320 radially inward of the inner column heater 360, as disclosed in United States Patent Application Publication No. 2022/0372636 (titled Electrolyzer System with Steam Generation and Method of Operating Same), filed on May 17, 2022, the contents of which are incorporated herein by reference in their entirety. In this embodiment, the outer column heater 350 may be referred to as an air heater, and the base heater 370 may be either present or omitted.

The steam heater 380 may comprise vertical loop-type heating coil heating element 382 disposed inside of the steam heater housing 384 located in central column 320. The steam heater heating element 382 may include a metallic heating core encased in insulation.

As shown in FIG. 3F, in operation, steam from the steam conduit 326 may flow downward through the steam recuperator 108, before exiting the bottom of the steam recuperator 108 and flowing upward along the housing 384 of the steam heater 380. In this embodiment, the steam recuperator 108 is located upstream of the steam heater 380. The steam may then flow upward to the top of the housing 384 before entering the housing 384 and flowing downward while being heated by the steam heater. The superheated steam may then exit the bottom of the steam heater 380 and flow into the steam inlet conduits 208, which may provide the superheated steam to corresponding stacks 100 or columns 101.

To increase the hydrogen production capacity of electrolyzer cell columns at a given system volume, the volume of components other than electrolyzer cell columns should be reduced to provide more volume for the electrolyzer cell columns. However, in prior electrolyzer cell systems, power is provided to internal heaters by electrical cables that are routed through a space created inside of the system support base. As such, the volume of the support base is increased to provide space for the electrical cables, which reduces the amount of space available for the electrolyzer cell columns at the given system volume. In various embodiments, heater busbars may be integrated into the system support base. The integrated heater busbars may have a smaller volume than the electrical cables, which may facilitate reduction of the support base volume and increase the amount of space available to the electrolyzer cell columns for a given system (e.g., cabinet or hotbox) volume.

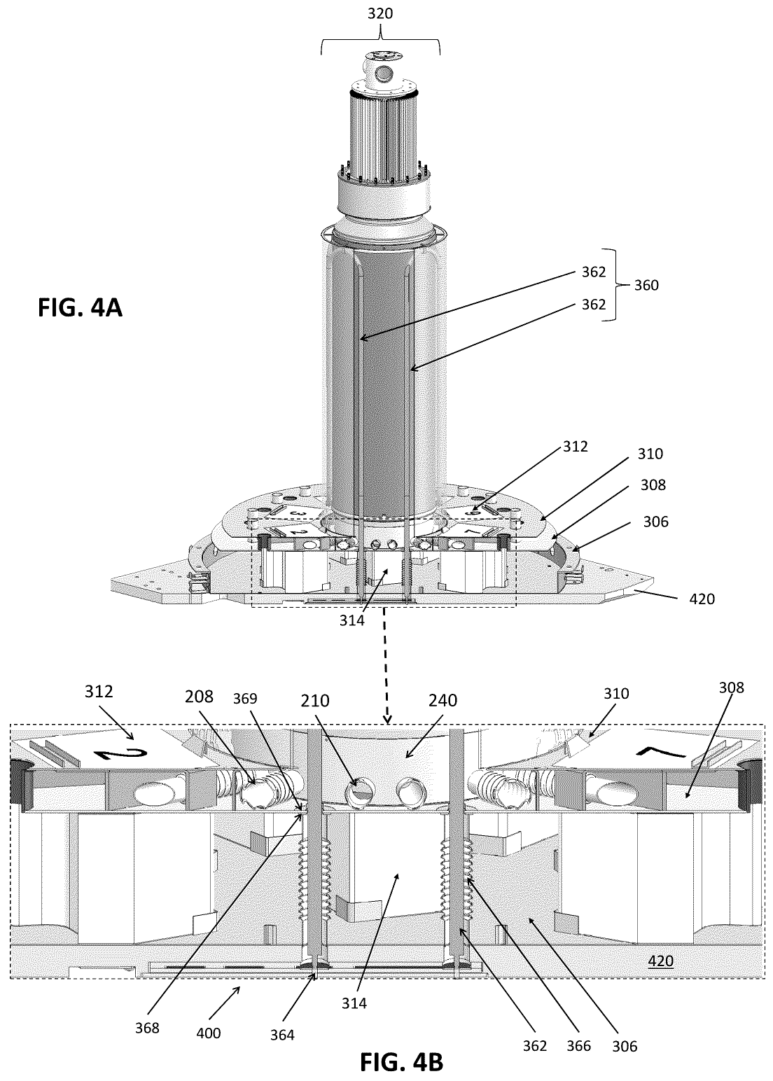

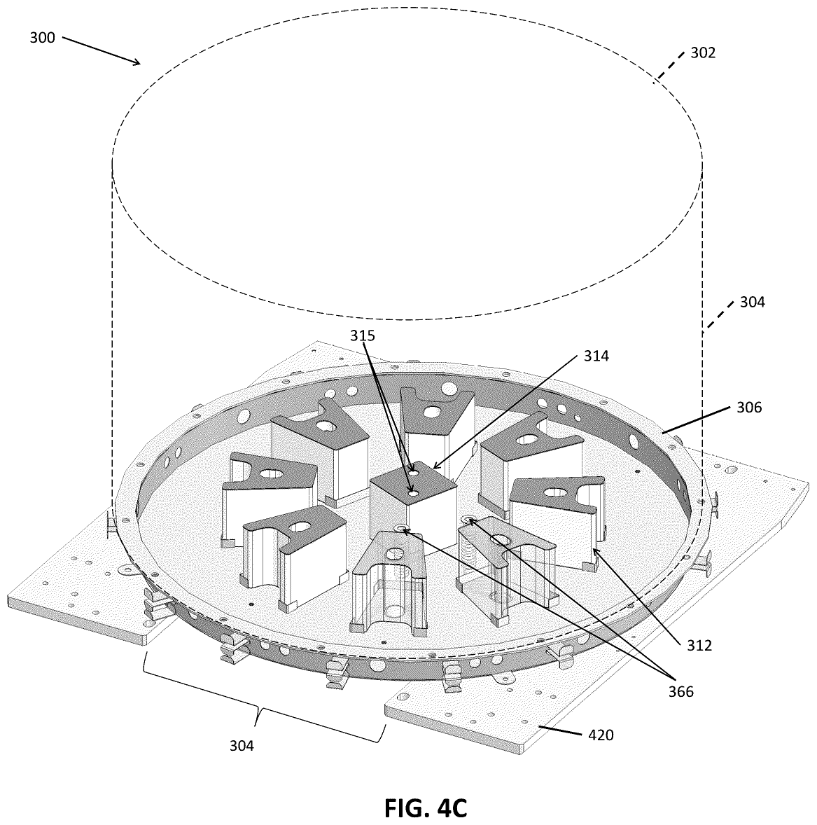

FIG. 4A is a cross-sectional view of the central column 320 and support base 420, according to various embodiments of the present disclosure, FIG. 4B is an enlarged view showing a portion of FIG. 4A, and FIG. 4C is a perspective view showing a base pan 306 of the hotbox 300 and the support base 420 of FIG. 4A.

Referring to FIGS. 3A-3F and 4A-4C, the hotbox 300 may include the cover plate 302, sidewall(s) 304, the base pan 306, a first subfloor 308 (or lower skirt plate 308), a second subfloor 310 (or upper skirt plate 310), cell column pedestals 312 and a central pedestal 314. The base pan 306 may form the bottom of the hotbox 300. The base pan 306 may be disposed on the support base 420, which may be configured to support the hotbox 300. For example, the support base 420 may be configured to support the hotbox 300 while the hotbox 300 is moved, for example, by a fork lift. In some embodiments, the support base 420 may be formed from a flat metal plate, such as a stainless steel plate or the like.

The cell column pedestals 312 and the central pedestal 314 may be disposed on the base pan 306. The pedestals 312, 314 may extend through the subfloors 308, 310. The cell columns 101 may be disposed on the cell pedestals 312, and the central column 320 (including the optional steam heater 380) may be disposed on the central pedestal 314. The fuel inlet conduits 208 and the hydrogen outlet conduits 210 may be disposed on the first subfloor 308 and may be covered by the second subfloor 310. The hub 240 may be located on the first subfloor 308 and may be located at the bottom of the central column 320.

The inner column heater 360 may include one or more heating elements 362. The heating element(s) 362 may be vertical loop-type heating coil(s) disposed around the central column 320. In some embodiments, at least a portion of each heating element 362 may be embedded in a tubular insulation layer (not shown), such as a ceramic fiber insulation layer. Each heating element 362 may extend through openings in the subfloors 308, 310, the base pan 306, and the support base 420. Likewise, the heating element(s) 382 of the steam heater 380 (if present) may extend through respective openings 315 (see FIG. 4C) in the central pedestal 314, the subfloors 308, 310, the base pan 306, and the support base 420.

Bellows 366 may be disposed between the first subfloor 308 and the base pan 306 and may surround each heating element 362. Compression of the bellows 366 between the first subfloor 308 and the base pan 306 may operate to seal the heating elements 362. Terminals 364 of the heating elements 362 may be electrically connected to a busbar assembly 400 integrated with the bottom of the support base 420. Likewise, additional bellows (not shown) may be located below the openings 315 in the central pedestal 314 between the first subfloor 308 and the base pan 306, and may surround the heating element(s) 382 of the steam heater 380.

Compression seals 368 and upper “top hat” seals 369 may be located below and above the first subfloor respectively, to seal the bellows 366 to the first subfloor 308. In that configuration, the seals 368, 369 seal the first heating element 362 between the first subfloor 308 and the base pan 306.

Although not shown in FIGS. 4A and 4B, the optional base heater 370 may be disposed between the subfloors 308, 310 to heat at least the fuel inlet conduits 208.

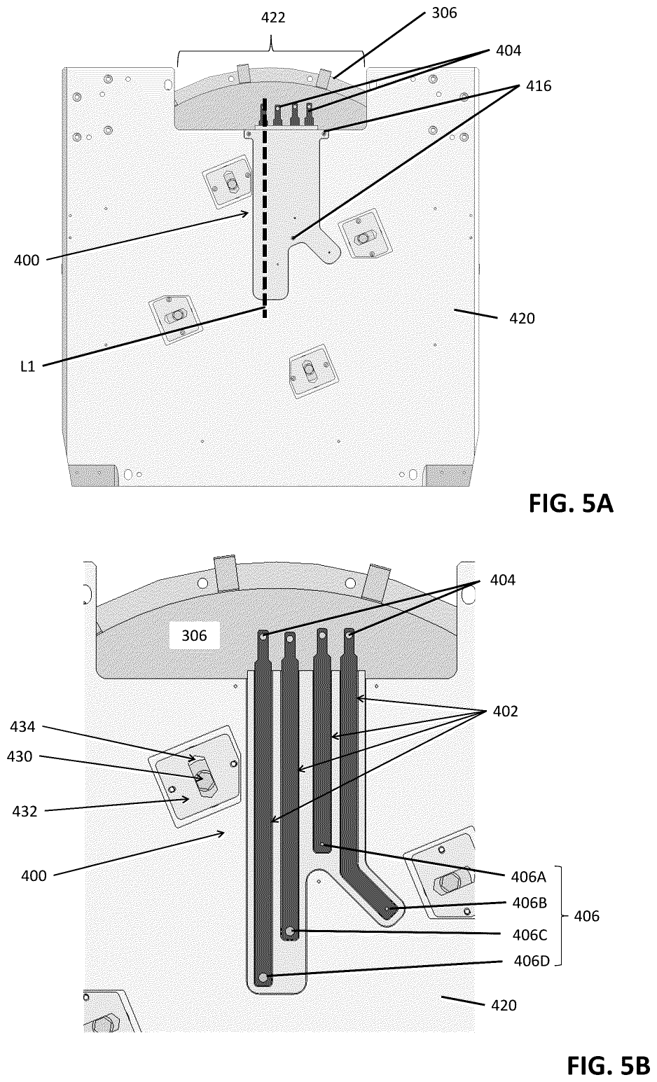

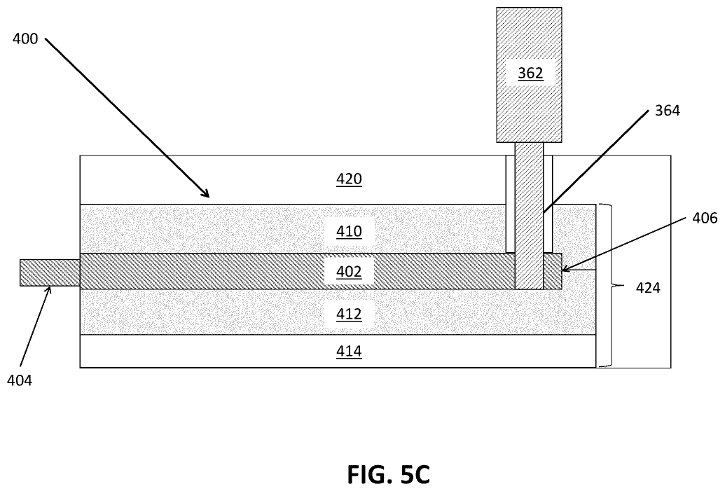

FIG. 5A is a plan view showing the bottom of the support base 420 of FIG. 4A, FIG. 5B is an enlarged view showing the busbar assembly 400 of FIG. 5A with a cover plate removed, and FIG. 5C is a cross-sectional view of the busbar assembly 400 taken along line L1 of FIG. 5A.

Referring to FIGS. 5A-5C, the busbar assembly 400 may include conductive busbars 402 (e.g., leads), an upper dielectric layer 410, a lower dielectric layer 412, and a cover plate 414. The busbars 402 may comprise metal or metal alloy strips or bars having a relative narrow height. In one embodiment, the busbars 402 may comprise flat conductive strips. The upper and lower dielectric layers 410, 412 may be disposed above and below the busbars 402. In one embodiment, the busbars 402 may be formed of a highly conductive metal or alloy, such as copper, a copper alloy (e.g., a Cu—Al alloy), or the like.

The dielectric layers 410, 412 may be formed of a compliant and heat-resistant material, such as a mica sheet or another ceramic material. The dielectric layers 410, 412 may be configured to maintain lateral electrical separation of the busbars 402 from each other, and to electrically isolate the busbars 402 from the support base 420 and from the cover plate 414. The cover plate 414 may be formed of any suitable material, such as a ceramic material, or a conductive material, such as a metal or metal alloy, e.g., stainless steel or the like.

In some embodiments, the busbar assembly 400 may be embedded into the support base 420, such that the outward facing bottom surface of the cover plate 414 may be substantially coplanar with the bottom surface of the support base 420. In other words, at least the dielectric layers 410, 412 and the busbars 402 may be disposed between the upper and lower surfaces of the support base 420 (e.g., within the assembly recess 424). In some embodiments, at least a portion of the cover plate 414 may also be disposed within the assembly recess 424 in the support base 420.

The busbar assembly 400 may include any suitable number of busbars 402, such as from two to ten busbars 402. The busbars 402 may each include an external terminal 404 and an internal terminal 406. The terminals 404 and 406 may comprise recesses or through holes in the busbars 402. The external terminals 404 may be aligned with one another to allow easy connection to an external power and/or grounding source, such as a power cable or the like. The internal terminals 406 may be disposed in various positions, depending on the location of elements to be connected thereto. For example, two of the internal terminals 406A and 406B may be positioned so as to be vertically aligned with terminals of the heating element 362, while two other internal terminals 406C and 406D may be vertically aligned with terminals of the heating elements 382 of the steam heater 380.

The terminals (e.g., bottom heater pins) 364 of the heating elements 362 may be inserted through openings in the support base 420, the upper dielectric layer 410, and into corresponding internal terminals 406A and 406B. The terminals 364 of the heating elements 362 may then be welded to the internal terminals 406 of the busbars 402. If the internal terminals 406 comprise through holes through the busbars 402, any parts of the terminals 364 of the heating element 362 that protrude below the busbars 402 after the welding may be removed by grinding or another method, in order to provide a flat bottom surface of the busbars 402. The lower dielectric layer 412 may then be disposed on the busbars 402, and the cover plate 414 may be attached to the support base 420, to secure the busbar assembly in the support base 420. For example, the cover plate 414 may be secured using fasteners 416, such as bolts, screws, clips, or the like designed to connect the cover plate 414 to the support base 420.

The support base 420 may include an access recess 422 configured to provide access to the external terminals 404 of the busbar assembly 400, and an assembly recess 424 in which the busbar assembly 400 is disposed. In particular, the access recess 422 may be a cut-out formed in the support base 420 that is configured to allow access to the busbar assembly 400 below the base pan 306. In particular, the access recess 422 may allow for the exterior terminals 404 to be exposed from the support base 420 while disposed below the hotbox 300 for electrical connections to be established without requiring an increase in the footprint of the system. The assembly recess 424 may allow for the cover plate 414 to lie flush or substantially flush with the bottom surface of the support base 420, such that the busbar assembly 400 does not increase the thickness of the support base 420.

The compact design and integration of the busbar assembly 400 in the support base 420 increases the volume available for the hotbox 300 of a given height disposed on the support base 420, and thus, increases the space available for the cell columns 101 inside the hotbox 300. The terminals 364 of the heating elements 362 project down through the support base 420, such that the connection between the heating elements 362 and the busbars 402 are connected in a relatively cool location outside of the hotbox 300, which mitigates the risk of thermal deterioration. The positioning of the external terminals 404 also simplifies external electrical connections to the hotbox 300 components and allows for the use of electrical cables that are not rated for high temperature operation. Additionally, the integration of the busbar assembly 400 into the metallic support base 420 allows the support base 420 to act as a large thermal sink to help dissipate ohmic heating in the busbars 402. Lastly, during installation, the weld between the heating element terminals 364 (e.g., heater pin) and busbar 402 has a large surface area, which improves electrical conductivity and limits hotspots.

In one embodiment, the bottom of the support base 420 may also include seismic bolts 430 and flag plates 432 that lock in the seismic bolts. The slot 434 in the flag plate 432 prevents the seismic bolt 439 from turning out due to vibration or thermal expansion. The seismic bolts 430 are used to secure the hotbox 300 components to the support base 420.

In some embodiments, the busbar assembly 400 may also be used to electrically connect other system components to external power cables. For example, the busbar assembly 400 may be used to provide power to the electrolyzer cell columns 101.

In various embodiments, an electrochemical system, such as an electrolyzer cell system 200 described above, may include one or more heaters 350, 360, 370, 380 having electric heating elements, such as resistive or inductive heating elements. In some embodiments, the heater(s) may be located within the hotbox 300 of the electrolyzer cell system 200, and may be exposed to process gases (e.g., air inlet stream, oxygen enriched air exhaust stream, etc.). The heater(s) may include a heating element composed of a suitable material, such as a metallic material (e.g., a nickel-chromium alloy, stainless steel, etc.) and/or a non-metallic material, such as silicon carbide, graphite, or the like. The heating element may be surrounded by an outer protective sheath. In many electric heaters for electrochemical systems as described above, the outer sheath of the heater is typically composed of a chromia former alloy, such as an Inconel® 600 alloy. An outer sheath formed of a chromia former alloy will develop a protective scale of chromia (i.e., chromium oxide (Cr₂O₃)) on its surface when exposed to a high-temperature oxidizing environment. This chromia scale may enhance the heater's resistance to oxidation, corrosion, and wear.

However, it has been found that the chromia scale that forms on an outer sheath formed of a chromia former alloy, such as an Inconel® 600 alloy, may result in the formation of hexavalent chromium (“hex-chrome”) vapors, such as CrO₃ and/or CrO(OH)₂ vapors, at temperatures encountered within the hotbox 300 of an electrolyzer cell system 200. These hex-chrome vapors may damage components of the electrochemical system, including the cathode electrodes of the electrolyzer cell system 200.

Various embodiments of the present disclosure are directed to heaters for electrochemical systems including an aluminum-rich outer surface. In some embodiments, the aluminum-rich outer surface of the heater may include at least 2 weight percent (wt %) aluminum, including at least 3 wt % aluminum, such as at least 4 wt % aluminum. For example the aluminum-rich outer surface of the heater may include 2 to 35 wt % aluminum, including 2 to 8 wt % aluminum. In one embodiment, the aluminum-rich outer surface of the heater may include 3 to 30 wt % aluminum, including 3 to 8 wt % aluminum, such as 3 to 6 wt % aluminum, or 3 to 5 wt % aluminum. In another embodiment, the aluminum-rich outer surface of the heater may include 4 to 30 wt % aluminum, including 4 to 8 wt % aluminum, such as 4 to 6 wt % aluminum, or 4 to 5 wt % aluminum. The aluminum-rich outer surface of the heater may promote the formation of an alumina scale rather than a chromia scale in a high-temperature oxidating environment. The alumina scale protects the heater from the high-temperature oxidizing environment and does not produce hex-chrome vapors which may damage cathode electrodes of the electrolyzer cell system 200.

In one embodiment, the outer sheath of the heater may be composed of an alumina former alloy that promotes the formation of an alumina scale over the outer sheath in the operating environment of the electrochemical system. Alternatively, or in addition, the heater may include an aluminum-rich coating, such as a nickel-aluminum intermetallic coating, over the outer sheath that may promote formation of alumina scale in the operating environment of the electrochemical system. Accordingly, alumina scale may preferentially form relative to chromia scale over the outer surface of the heater, which may greatly reduce or eliminate the formation of harmful hex-chrome vapors during operation of the heater. In addition, because alumina scale tends to form more slowly than chromia scale, the useful lifetime of the heater may be increased.

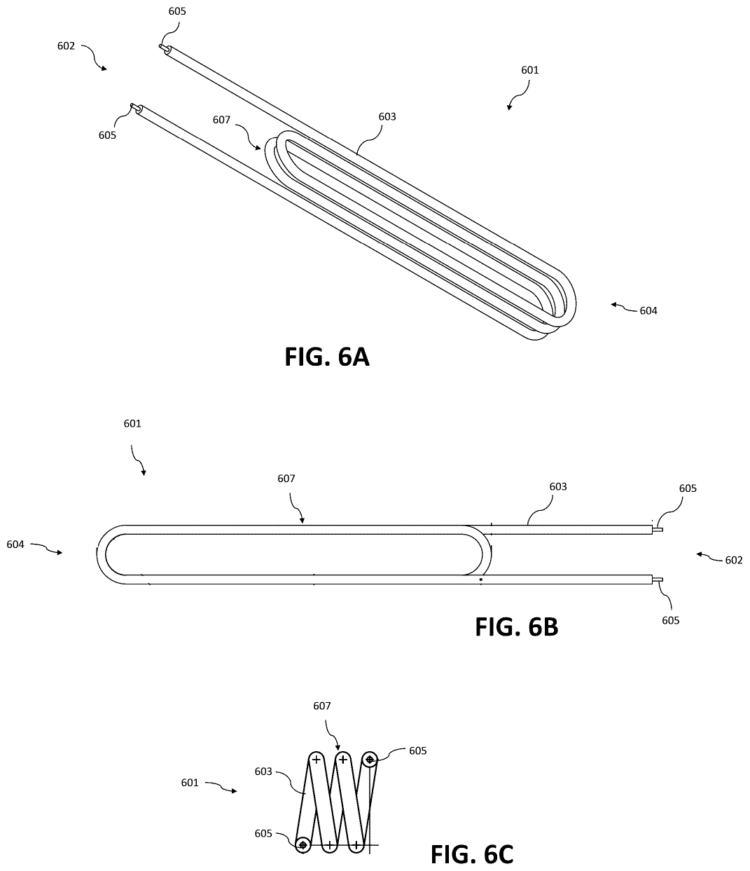

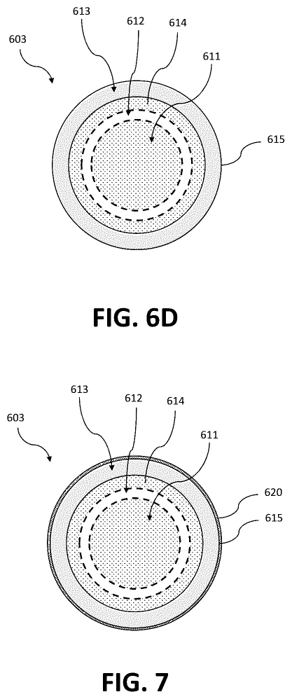

FIG. 6A is a perspective view of a heater 601 for an electrochemical system according to various embodiments of the present disclosure. FIG. 6B is a side elevation view of the heater 601 of FIG. 6A. FIG. 6C is a bottom view of the heater 601 of FIG. 6A. FIG. 6D is a cross-sectional view of a portion of the heater 601 of FIG. 6A. Referring to FIGS. 6A-6D, the heater 601 may include a main body 603 extending between a pair of terminals (e.g., pins) 605. The terminals 605 may be located on a first end 602 (e.g., a bottom end) of the heater 601, and the main body 603 may extend from the terminals 605 towards a second end 604 (e.g., top end) of the heater 601. In some embodiments, the main body 603 of the heater 601 may include a curved or bent shape at the second end 604 of the heater 601 such that the outer surface of the heater 601 may have a generally “U”-shape. In some embodiments, the main body 603 of the heater 601 may be wound in a coil shape to form at least one loop segment 607 adjacent to the second end 604 of the heater 601. The embodiment of FIGS. 6A-6C includes two complete loop segments 607, although it will be understood that the heater 601 may include a greater or lesser number of loop segments 607. In some embodiments, each of the loop segments 607 may have an elliptical shape with a major axis along the length of the heater 601 between the first and second ends 602 and 604 of the heater 601 and a minor axis along the width of the heater 601. Other shapes of the loop segment(s) 607, such as circular or rectangular shapes, are within the contemplated scope of disclosure. It will be further understood that other configurations for the heater 601, including alternative shapes for the main body 603, are within the contemplated scope of the disclosure.

FIG. 6D is a cross-section view of a portion of the main body 603 of the heater 601 according to various embodiments. The main body 603 of the heater 601 may have a generally cylindrical cross-section. Thus, the heater 601 may also be referred to as a “tubular heater” 601. The main body 603 may include a heater core 611 and an outer sheath 613 surrounding the heater core 611. In various embodiments the heater core 611 may include a resistive heating element 612, which may include a wire coil (schematically indicated by dashed lines in FIG. 6D) extending along the length of the main body 603 that may be electrically coupled between the pair of terminals 605 (e.g., pins) (see FIGS. 6A-6C) of the heater 601. In some embodiments, the resistive heating element 612 may include a nickel-chromium alloy (nichrome). Other suitable heating elements 612 may also be utilized. In some embodiments, the heating element 612 may include a metal alloy containing aluminum, such as an iron-chromium-aluminum (FeCrAl) alloy that may optionally also include yttrium (Y). The heating element 612 may be surrounded by an electrically insulating material 614 that may provide effective dielectric strength and heat transfer capability at elevated temperatures. In some embodiments, the electrically insulating material 614 may include magnesium oxide (MgO), although other suitable electrically insulating materials are within the contemplated scope of disclosure.

The outer sheath 613 of the main body 603 may surround the heater core 611 and may form the outer surface 615 of the main body 603 of the heater 601. In various embodiments, the outer sheath 613 may include an alumina former alloy. An alumina former alloy (which may also be referred to as an alumina forming alloy) is an alloy that promotes the formation of a protective scale of alumina (i.e., aluminum oxide (Al₂O₃)) on its surface when exposed to a high-temperature oxidizing environment. In various embodiments, the outer sheath 613 may include an alumina former alloy having at least about 2 wt % aluminum, such as at least about 3 wt % aluminum, including at least about 4 wt % aluminum.

In some embodiments, the outer sheath 613 may be composed of a nickel-based alumina former alloy having at least about 2 wt % aluminum. In one embodiment, suitable nickel-based alumina former alloys may include, for example, a Haynes® 214 alloy or a Haynes® 224 alloy. These alloys include nickel as a majority component and contain at least 3 wt % of aluminum, iron and chromium.

Haynes® 214 alloy is nickel-chromium-aluminum-iron alloy, having the following composition in weight percent: Nickel: 75% (balance), Chromium: 16%, Aluminum: 4.5%, Iron: 3%, Cobalt: up to 2% maximum, Manganese: up to 0.5% maximum, Molybdenum: up to 0.5% maximum, Titanium: up to 0.5% maximum, Tungsten: up to 0.5% maximum, Niobium: up to 0.15% maximum, Silicon: up to 0.2% maximum, Zirconium: up to 0.1% maximum, Carbon: 0.04 Boron: up to 0.01% maximum, and Yttrium: 0.01%.

Haynes® 214 alloy is a wrought Ni-27.5Fe-20Cr-3.8Al alloy having the following composition in weight percent: Nickel: 47% (balance), Iron: 27.5%, Chromium: 20%, Aluminum: 3.8%, Cobalt: up to 2 maximum, Manganese: up to 0.5% maximum, Molybdenum: up to 0.5% maximum, Titanium: up to 0.3% maximum, Tungsten: up to 0.5% maximum, Silicon: 0.3%, Niobium: up to 0.15% maximum, Carbon: 0.05%, Boron: up to 0.004% maximum, and Zirconium: up to 0.025% maximum.

Iron-based alumina former alloys may also be utilized for the outer sheath 613, such as FeCrAl alloys, which may optionally include Y (i.e., FeCrAlY). These alloys include Cr, Al, optionally Y or Mo, and balance Fe (e.g., the alloys comprise iron as a majority component and contain 4 to 6 wt % of aluminum and 20 to 25 wt % chromium). For example, the Kanthal® APM alloy includes 22 wt % Cr, 5.8 wt % Al and balance Fe, the Kanthal® APM alloy includes 22 wt % Cr, 5.8 wt % Al, Mo and balance Fe, the Kanthal® AF alloy includes 22 wt % Cr, 5.3 wt % Al, Y and balance Fe, while the Kanthal® D alloy includes 22 wt % Cr, 4.8 wt % Al, and balance Fe.

Other iron-based alumina former alloys may also be utilized for the outer sheath 613, such as the OC-11 alloys developed by Oak Ridge National Laboratory and described in U.S. Pat. Nos. 7,754,144, 8,431,0772, and 7,744,813, which are incorporated herein by reference in their entirety. The OC-11 alloys include, in weight percent:

| | U.S. Pat. No. | U.S. Pat. No. | U.S. Pat. No. |
|---|---|---|---|
| Element | 7,754,144 | 8,431,0772 | 7,744,813 |
| Fe | balance | balance | balance |
| Cr | 10-15 | 10-25 | 10-25 |
| Ni | 15-30 | 8-37 | 10-37 |
| Al | 2-5 | 2.5-5 | 2-3.5 |
| Nb | 0.6-5 | 0.6-2.5 | 0-1 |
| C | 0.05-0.15 | 0.15-0.5 | 0.03-0.15 |

Furthermore, OBH iron-based alumina former alloys may also be utilized for the outer sheath 613. The OBH alloys are alumina-forming austenitic (AFA) alloys, which are austenitic stainless steels which have the following composition, in weight percent: Fe: balance, Ni: 20-30%, such as 20-25%, including 25%, Cr: 13-18%, preferably 14.5 to 18%, such as 14.5 to 16% or 16 to 18%, Al: 3.5 to 5%, such as 4%, Nb: 1 to 2.5%, preferably 1.5 to 2.5%, Mn: 0.5-2%, Si: 0.15-0.5%, Zr: 0.05-0.2%, Hf: 0.05-0.2%, C: 0.02-0.2%, preferably 0.02 to 0.05%, such as 0.02 to 0.03%, and B: 0.005-0.015%. These alloys may optionally also include at least one of W, Mo, Cu, Ti and/or V, such as W: 0-2%, Mo: 0-2%, Cu: 0-1%, Y: 0-0.1% and/or Ti: 0-0.1%.

Thus, the OC-11 and OBH alloys comprise iron-based alumina former alloys which comprise an iron-chromium-nickel-aluminum-niobium alloy comprising iron as a majority component.

The tubular heater 601 as shown in FIGS. 6A-6D may be incorporated into an electrochemical system, such as an electrolyzer cell system 200 as described above. The tubular heater 601 may be located within a hotbox 300 of the electrolyzer cell system 200. In some embodiments, the terminals 605 of each of the heaters 601 may be electrically connected to a busbar assembly as described above. In some embodiments, one or more tubular heaters 601 may be utilized to directly heat electrolyzer cell columns 101 within the hotbox 300. Alternatively, or in addition, one or more tubular heaters 601 may be utilized to heat a reactant (e.g., steam) that is provided to the electrolyzer cell columns 101.

A tubular heater 601 of FIGS. 6A-6D may function as any of the heaters 350, 360, 370, 380 described above. For example, the tubular heater 601 may correspond to the inner column heater 360 shown in FIG. 4A. During operation of the electrolyzer cell system 200, the high temperature oxidizing environment within the hotbox 300 may result in the formation of an oxide scale over the outer surface 615 of the outer sheath 613 of the heater 601. FIG. 7 is a cross-section view of a portion of the main body 603 of a tubular heater 601 according to various embodiments of the present disclosure. FIG. 7 illustrates the formation of an oxide scale 620 over the outer surface 615 of the outer sheath 613 of the heater 601. As discussed above, the oxide scale 620 may enhance the heater's resistance to oxidation, corrosion, and wear. The aluminum-rich outer surface 615 of the outer sheath 613 of the heater 601 may promote the formation of alumina scale on the outer sheath 613. In some embodiments, the ratio of the wt % of alumina to the wt % of chromia in the oxide scale 620 may be at least 2:1, including at least 5:1, such as 10:1 or more, including substantially no chromia (i.e., 99.9 to 100 wt % alumina). Accordingly, the relatively higher quantity of alumina compared to chromia in the protective oxide scale 620 may eliminate or significantly reduce the formation of harmful chromia by-products, such as hex-chrome vapors. In addition, because alumina scale tends to form more slowly than chromia scale, the useful lifetime of the heater may be increased.

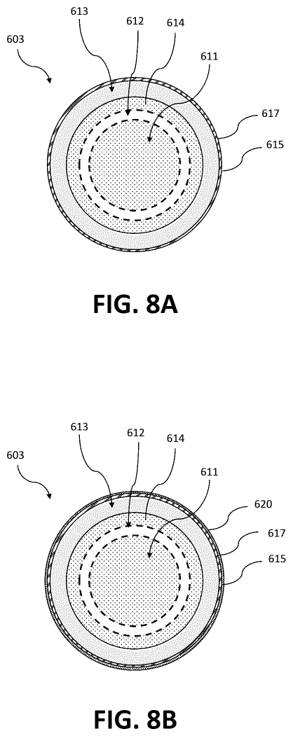

FIG. 8A is a cross-section view of a portion of a main body 603 of a heater 601 according to an alternative embodiment of the present disclosure. The main body 603 shown in FIG. 8A may be similar to the main body 603 described above with reference to FIGS. 6A-6D. Thus, repeated discussion of like features is omitted for brevity. The main body 603 of heater 601 in FIG. 8A includes an outer sheath 613 surrounding the heater core 611, and an aluminum-rich outer coating 617 over the outer sheath 613. Thus, the aluminum-rich outer coating 617 may form the outer surface 615 of the main body 603 of the heater 601 in the embodiment of FIG. 8A. In various embodiments, the outer coating 617 may include at least about 2 wt % aluminum, such as at least about 3 wt % aluminum, including at least about 4 wt % aluminum. The outer sheath 613 on which the aluminum-rich outer coating 617 is formed may or may not include aluminum. For example, the outer sheath 613 may be composed of an alumina former alloy as described above with reference to FIGS. 6A-6D. Alternatively, the outer sheath 613 may be composed of a nickel based chromia former alloy, such as an Inconel® 600 alloy, which does not include aluminum, or another suitable metallic material. Inconel® 600 alloy is a Ni—Cr—Fe alloy that includes, in weight percent: Nickel: 72% minimum, Chromium: 14-17%, Iron: 6-10%, Manganese: 1% maximum, Copper: 0.5% maximum, Silicon: 0.5% maximum, Carbon: 0.15% maximum, and Sulfur: 0.01% maximum.

In some embodiments, the aluminum-rich outer coating 617 on the outer sheath 613 may be formed by a slurry aluminizing process. In some embodiments, the aluminum-rich outer coating 617 may include a pure aluminum, an aluminum-silicon, a nickel-aluminum or a chromium-aluminum intermetallic coating. In some embodiments, forming the aluminum-rich outer coating 617 may include preparing an aluminide slurry, and coating the slurry onto the outer sheath 613. This may include mixing slurry precursors, such as aluminum and optionally nickel, chromium or silicon powders, in a suitable water-based or solvent-based carrier medium to form the slurry. Alternatively, a commercially available aluminide, silicon-aluminide, nickel-aluminide or chromium-aluminide slurry, such as SermAlcote 2525 from Praxair (which is believed to contain a Cr—Al slurry and a halide activator described in U.S. Pat. No. 9,771,644 and US Patent Publication U.S. 2014/0219884 A1, which are incorporated by reference herein) or LSR SiAloy H2O from CeralUSA (which is believed to be a water based aluminum or aluminum-silicon containing slurry), may be utilized. The outer sheath 613 may be prepared by cleaning and performing an optional surface roughening process.

To form the outer coating 617, the nickel-aluminide slurry may be applied to the outer sheath 613 by a suitable process, such as by dipping (i.e., dipping the sheath 617 into the slurry), brushing or spraying. A heat treatment may then be performed at an elevated temperature, such as between 600-1000° C., although greater and lesser temperatures may also be utilized for the heat treatment. During the heat treatment, aluminum from the slurry may react with elements from the underlying alloy of the outer sheath 613 to form intermetallic compounds(s) such as NiAl or Ni₃Al. The intermetallic compound(s) may form over the surface of the outer sheath 613 to provide the aluminum-rich outer coating 617 over the surface of the outer sheath 613. Other suitable methods for forming an aluminum-rich outer coating 617 over the outer sheath 613, such as a pack cementation method, may also be utilized. The outer coating 617 may provide an aluminum-rich surface that will promote formation of a protective alumina scale as opposed to a chromia scale. In some embodiments, the outer coating 617 over the outer sheath 613 may include up to 35 wt % aluminum, such as 2 to 30 wt % aluminum, including 22 to 30 wt % aluminum. In one embodiment, the outer coating may include 3 to 30 wt % aluminum, including 25 to 30 wt % aluminum.

FIG. 8B is a cross-section view of a portion of the main body 603 of the tubular heater 601 of FIG. 8A following the formation of an oxide scale 620 over the aluminum-rich outer coating 617. As in the embodiment described above with reference to FIG. 7, the ratio of the wt % of alumina to the wt % of chromia in the oxide scale 620 may be at least 2:1, including at least 5:1, such as 10:1 or more. Accordingly, the relatively higher quantity of alumina compared to chromia in the protective oxide scale 620 may reduce or eliminate the formation of harmful chromia by-products such as hex-chrome vapors. In addition, because alumina scale tends to form more slowly than chromia scale, the useful lifetime of the heater may be increased.

Various embodiments of the present disclosure are designed to generate hydrogen for use as a carbon-free fuel to thereby reduce greenhouse gas emissions and provide a positive impact on the climate.

The preceding description of the disclosed aspects is provided to enable any person skilled in the art to make or use the present invention. Various modifications to these aspects will be readily apparent to those skilled in the art, and the generic principles defined herein may be applied to other aspects without departing from the scope of the invention. Thus, the present invention is not intended to be limited to the aspects shown herein but is to be accorded the widest scope consistent with the principles and novel features disclosed herein.

1. A heater, comprising:
a pair of terminals; and
a main body, comprising:
a heater core comprising a heating element electrically coupled between the pair of terminals; and
an outer sheath surrounding the heater core, wherein an outer surface of the main body comprises at least 2 weight percent (wt %) aluminum.

2. The heater of claim 1, wherein the outer surface of the main body comprises at least 3 wt % aluminum.

3. The heater of claim 2, wherein the outer surface of the main body comprises 3 to 8 wt % aluminum.

4. The heater of claim 1, wherein the outer sheath comprises an alumina former alloy that forms the outer surface of the main body.

5. The heater of claim 4, wherein the outer sheath comprises a nickel-based alumina former alloy.

6. The heater of claim 5, wherein the nickel-based alumina former alloy comprises an alloy comprising nickel as a majority component and containing at least 3 wt % of aluminum, iron and chromium.

7. The heater of claim 4, wherein the outer sheath comprises an iron-based alumina former alloy.

8. The heater of claim 7, wherein the iron-based alumina former alloy comprises a FeCrAl or FeCrAlY alloy comprising iron as a majority component and containing 4 to 6 wt % of aluminum and 20 to 25 wt % chromium.

9. The heater of claim 7, wherein the iron-based alumina former alloy comprises an iron-chromium-nickel-aluminum-niobium alloy comprising iron as a majority component.

10. The heater of claim 1, wherein the main body further comprises an outer coating over the outer sheath, wherein the outer coating forms the outer surface of the main body.

11. The heater of claim 10, wherein:
the outer coating comprises an intermetallic coating comprising nickel and up to 35 wt % of aluminum;
the outer sheath comprises a chromia former alloy; and
the outer coating comprises an alumina former alloy that forms the outer surface of the main body.

12. The heater of claim 1, wherein the pair of terminals are located on a first end of the heater, and the main body forms at least one loop segment that extends away from the pair of terminals to a second end of the heater.

13. An electrolyzer cell system, comprising:
a hotbox;
columns of electrolyzer cells disposed in the hotbox; and
a heater according to claim 1 disposed in the hotbox.

14. The electrolyzer cell system of claim 13, further comprising a central column disposed in the hotbox, wherein:
the columns of electrolyzer cells are disposed around the central column;
the heater is located between the central column and the columns of electrolyzer cells and is configured to heat the columns of electrolyzer cells; and
the electrolyzer cells comprise solid oxide electrolyzer cells.

15. The electrolyzer cell system of claim 14, further comprising a support base, wherein:
the support base includes an assembly recess containing two or more busbars, wherein each busbar contains an external terminal and an internal terminal; and
each terminal of the pair of terminals for the heater is attached an internal terminal of one of the busbars.

16. The electrolyzer cell system of claim 15, further comprising dielectric layers surrounding the busbars such that the busbars and dielectric layers are disposed between the upper and lower surfaces of the support base.

17. A method of operating an electrolyzer cell system comprising columns of electrolyzer cells and a heater comprising an alumina-forming outer surface disposed within a hotbox, the method comprising:
providing air and steam to the columns;
heating the columns using the heater;
electrolyzing the steam in the heated columns to generate hydrogen and oxygen;
providing a hydrogen containing product to a hydrogen processor and an oxygen enriched air exhaust stream from the heated columns; and
exposing the heater to at least one of the air or the oxygen enriched air exhaust stream to form an oxide scale comprising alumina over an outer surface of the heater.

18. The method of claim 17, wherein a ratio of a weight percent (wt %) of alumina to a wt % of chromia in the oxide scale is at least 2:1.

19. The method of claim 18, a ratio of the wt % of alumina to the wt % of chromia in the oxide scale is at least 10:1.

20. A method of fabricating a heater, comprising:
coating an outer sheath of the heater with an aluminide slurry; and
performing a heat treatment on the outer sheath coated with the aluminide slurry to form an aluminum-containing coating over the outer sheath of the heater.
